(19) United States
(12) Patent Application Publication
(10) Pub. No.: US 2016/0264096 A1
(43) Pub. Date: Sep. 15, 2016

(54) Latched Vehicle Safety Belt Detection Device

(71) Applicant: Dolores M. Barber, Denver, CO (US)

(72) Inventor: Dolores M. Barber, Denver, CO (US)

(21) Appl. No.: 14/295,440

(22) Filed: Jun. 4, 2014

(51) Int. Cl. B60R 22/48

(52) U.S. Cl. CPC B60R 22/48; B60R 22/105

(57) ABSTRACT

A latched vehicle safety belt detection device detects a safety belt remaining latched within a vehicle and gives a warning signal when a driver of the vehicle moves outside a set proximity from the vehicle. The device includes a vehicle having a safety belt positionable to secure a child seat within the vehicle while the safety belt is in a latched position. A detector is coupled to the safety belt to detect when the safety belt is in the latched position. A remote is provided. A proximity sensor detects when the remote is within a set proximity of the proximity sensor. An indicator is actuated when the detector detects the safety belt is in the latched position and the remote is outside of the set proximity of the proximity sensor.

### BACKGROUND OF THE DISCLOSURE

### Field of the Disclosure

The disclosure relates to safety belt detection devices and more particularly pertains to a new safety belt detection device for detecting a safety belt remaining latched within a vehicle and giving a warning signal when a driver of the vehicle moves outside a set proximity from the vehicle.

### SUMMARY OF THE DISCLOSURE

An embodiment of the disclosure meets the needs presented above by generally comprising a vehicle having a safety belt positionable to secure a child seat within the vehicle while the safety belt is in a latched position. A detector is coupled to the safety belt to detect when the safety belt is in the latched position. A remote is provided. A proximity sensor detects when the remote is within a set proximity of the proximity sensor. An indicator is actuated when the detector detects the safety belt is in the latched position and the remote is outside of the set proximity of the proximity sensor.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a latched vehicle safety belt detection device according to an embodiment of the disclosure.

FIG. 2 is a top front side perspective view of alternative remotes of an embodiment of the disclosure.

FIG. 3 is a top view of a remote of an embodiment of the disclosure.

FIG. 4 is a front view of a remote of an embodiment of the disclosure.

FIG. 5 is a back view of an embodiment of the disclosure.

FIG. 6 is a schematic view of an embodiment of the disclosure.

### DESCRIPTION OF THE PREFERRED EMBODIMENT

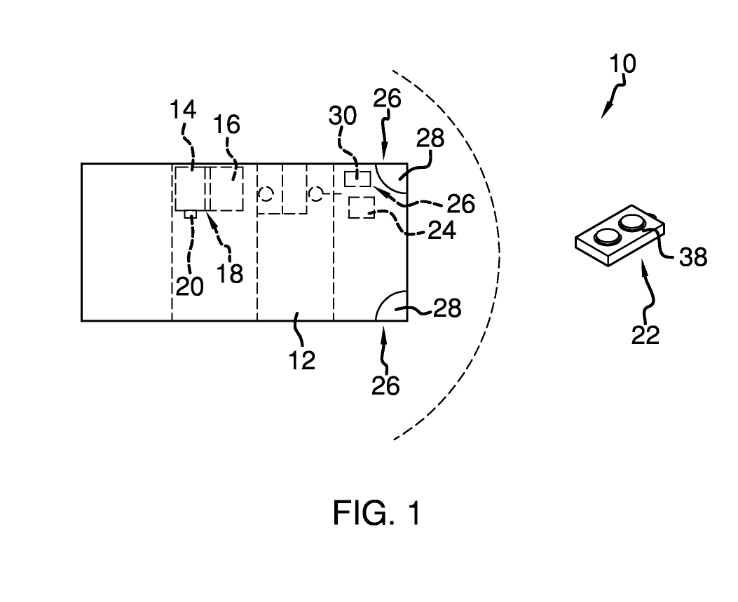

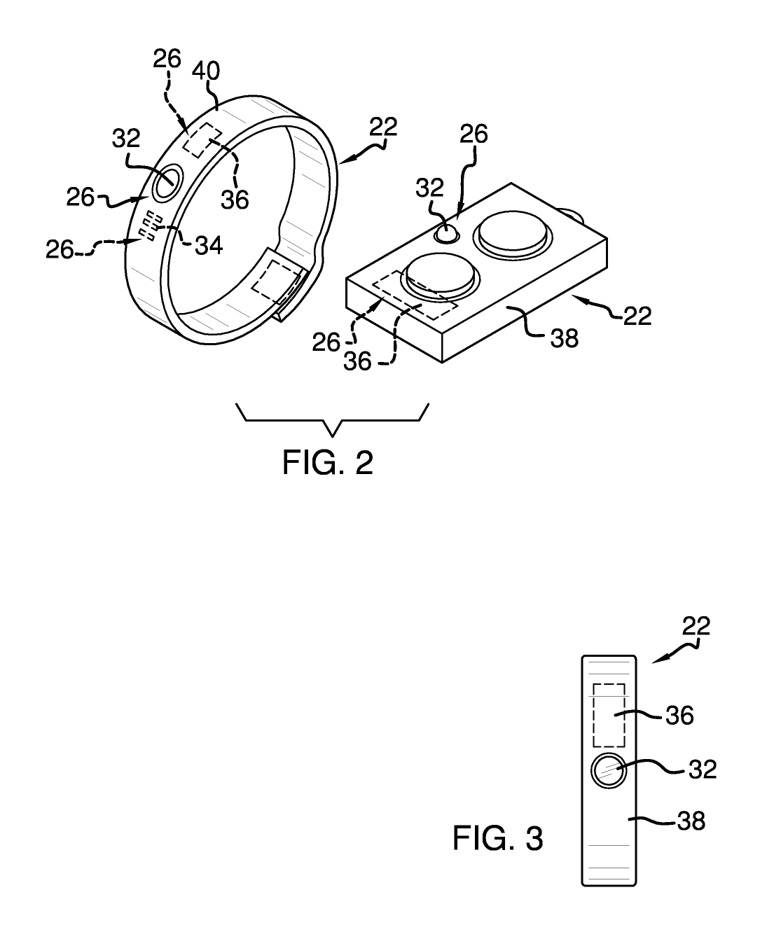

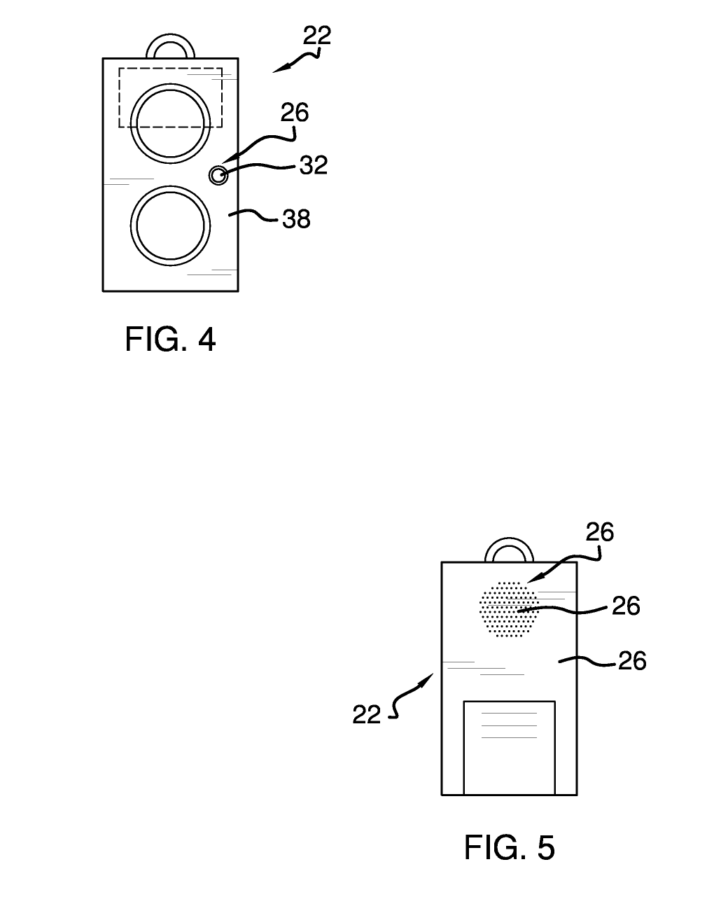

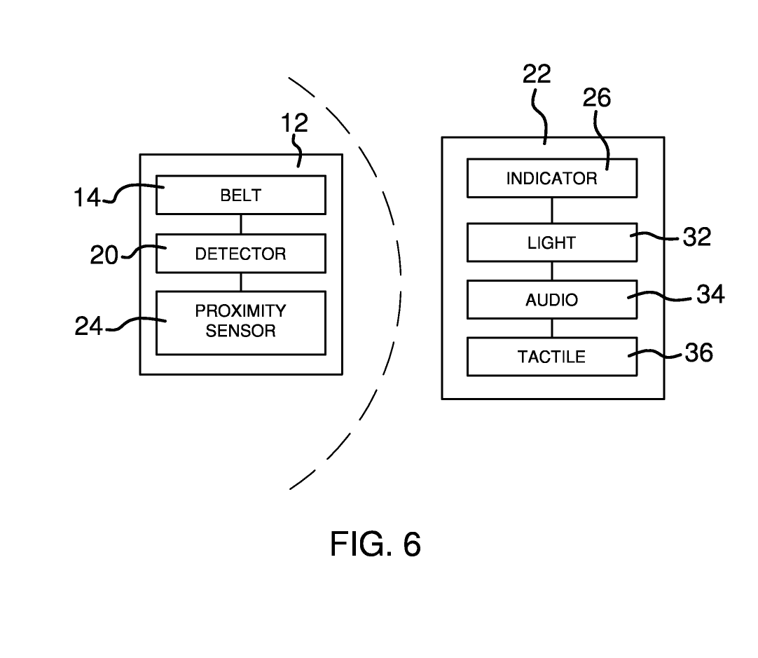

With reference now to the drawings, and in particular to FIGS. 1 through 6 thereof, a new safety belt detection device embodying the principles and concepts of an embodiment of the disclosure and generally designated by the reference numeral 10 will be described.

As best illustrated in FIGS. 1 through 6, the latched vehicle safety belt detection device 10 generally comprises a vehicle 12 having a safety belt 14 positionable to secure a child seat 16 within the vehicle 12 while the safety belt 14 is in a latched position 18. The safety belt 14 and vehicle 12 are of conventional design. A detector 20 is coupled to the safety belt 14 to determine when the safety belt 14 is in the latched position 18. A remote 22 is provided to be carried with or on a person. A proximity sensor 24 is coupled to one of the vehicle 12 and the remote 22. The proximity sensor 24 detects the remote 22 is within a set proximity of the vehicle 12. This may be achieved using conventional technology allowing for keyless starting and operation of vehicles. An indicator 26 is provided. The indicator 26 may take the form of being integrated into existing systems of the vehicle 12 such as the lights 28 and horn 30. Alternatively, the indicator 26 is coupled to the remote 22. The indicator 26 when coupled to the remote 22 may comprise a light 32, a speaker 34 to broadcast and audio signal, a vibrational unit 36 to provide a tactile alert when actuated, or a combination of the light 32, speaker 34, and vibrational unit 36. The remote 22 may take the form of a key fob 38, a bracelet 40, or another object carried by or attachable to a person.

In use, the indicator 26 is actuated when the detector 20 detects the safety belt 14 is in the latched position 18 and the remote 22 is outside of the set proximity of the proximity sensor 24. Thus, when the safety belt 14 is used to secure the child seat 16 to the vehicle 12 and the person moves outside a desired proximity of the vehicle 12 without unlatching the safety belt 14, the indicator 26 is actuated to alert the person a child may be left behind unattended in the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A latched vehicle safety belt detection device comprising:
a vehicle having a safety belt positionable to secure a child seat within said vehicle while said safety belt is in a latched position;
a detector coupled to said safety belt, said detector detecting said safety belt being in said latched position;
a remote;
a proximity sensor said proximity sensor detecting said remote being within a set proximity of said proximity sensor; and
an indicator, said indicator being actuated when said detector detects said safety belt is in said latched position and said remote is outside of said set proximity of said proximity sensor.

2. The device of claim 1, further comprising said indicator being coupled to said remote.

3. The device of claim 1, further comprising said indicator being an audible signal.

4. The device of claim 1, further comprising said indicator being a visual signal.

5. The device of claim 1, further comprising said remote being a key fob.

6. The device of claim 1, further comprising said remote being a wristband.

7. A latched vehicle safety belt detection device comprising:
a vehicle having a safety belt positionable to secure a child seat within said vehicle while said safety belt is in a latched position;
a detector coupled to said safety belt, said detector detecting said safety belt being in said latched position;
a remote;
a proximity sensor said proximity sensor detecting said remote being within a set proximity of said proximity sensor; and
an indicator, said indicator being actuated when said detector detects said safety belt is in said latched position and said remote is outside of said set proximity of said proximity sensor, said indicator being coupled to said remote, said indicator being an audible signal and a visual signal.

8. The device of claim 7, further comprising said remote being a key fob.

9. The device of claim 7, further comprising said remote being a wristband.
